(19) United States
(12) Patent Application Publication
(10) Pub. No.: US 2005/0111336 A1
(43) Pub. Date: May 26, 2005

(54) Objective lens element for optical disks and optical head device incorporating the same

(75) Inventors: Yasuhiro Tanaka, Nishinomiya (JP); Michihiro Yamagata, Osaka (JP); Akifumi Hashimoto, Katano (JP); Yuichi Takahashi, Kitakatsuragi-gun (JP); Yukihiro Chokyu, Onsen-gun (JP); Kei Ikeda, Matsuyama (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/985,906

(22) Filed: Nov. 12, 2004

(30) Foreign Application Priority Data
Nov. 20, 2003 (JP) JP 2003-390522

(51) Int. Cl. G11B 7/00

(52) U.S. Cl. 369/112.08; 369/112.23

(57) ABSTRACT

An objective lens records information on, or read information from, a first optical medium by utilizing a first light beam which convergences on the first optical medium at a first numerical aperture (hereinafter “NA1”). The objective lens records information on, or read information from, a second optical medium by utilizing a second light beam which convergences on the second optical medium at a second numerical aperture (hereinafter “NA2”). In the objective lens, NA1 is greater than NA2. The objective lens has an optical lens for receiving the first light beam and the second light beam. The optical lens has a peripheral diffraction structure disposed substantially outside an area of incidence of the second light beam for suppressing fluctuation in wavefront aberration of the first light beam, and a phase step structure disposed in a central region relative to the peripheral region for producing a phase difference in the second light beam.

### BACKGROUND OF THE INVENTION

1. Field of the Invention

The present invention relates to an objective lens element for use with optical disks such as a digital versatile disk (DVD) and a compact disc (CD), and an optical head device incorporating the objective lens element. More particularly, the present invention relates to an objective lens element which can be used for compatible reproduction/recording of both DVDs and CDs with only a single objective lens element, and an optical head device incorporating such an objective lens element.

2. Description of the Background Art

There have been proposed objective lens elements for permitting the recording/reproduction of both a digital versatile disk (hereinafter referred to as a “first optical disk”) and a compact disc (hereinafter referred to as a “second optical disk”) in a single optical disk recording/reproduction apparatus. The “first optical disk” differs from the “second optical disk” in terms of the light source wavelength and the thickness from the light-source side to the information recording surface (hereinafter any reference to a “thickness” of an optical disk refers to this thickness).

For example, Japanese Laid-Open Patent Publication No. 2002-150595, Japanese Laid-Open Patent Publication No. 11-337818, and Japanese Laid-Open Patent Publication No. 2000-081566 each disclose an objective lens element diffraction elements which are integrated with an objective lens element so as to converge optimum spots respectively for the first and second optical disks. There are also known techniques which provide a design such that a beam of parallel light enters an objective lens element for the first optical disk, while, for the second optical disk, a beam of divergent light enters the objective lens element, thus correcting for the spherical aberration due to differences in thickness and wavelength between the optical disks.

Furthermore, an objective lens element incorporating a diffraction elements are characterized by minute saw-tooth-like diffraction features formed on its lens surface. Therefore, producing an objective lens element incorporating diffraction elements requires performing fine processing for a mold which is used for the formation of the lens. For this reason, a resin objective lens element is employed since a mold therefor can be produced relatively easily.

However, a technique employing diffraction elements require the diffraction elements to be formed over the entire surface of an objective lens element, so that the efficiency of light utility decreases due to a poorer diffraction efficiency as compared to that of a usual refractive surface. A slight decrease in the efficiency of light utility would not be problematic to an optical disk apparatus which is only capable of reproduction, since more than adequate laser output is available. On the other hand, any decrease in the efficiency of light utility can be very problematic to an apparatus which is capable of recording.

Meanwhile, in the technique which allows divergent light to enter the objective lens element when using the second optical disk, the objective lens element presents a finite system with respect to the second optical disk. Since the objective lens element is basically optimized for the first optical disk, some deteriorations in the optical characteristics of the objective lens element, with respect to an off-axis light beam, will inevitably result for the second optical disk. As a result, due to positioning margins for the objective lens element and due to lens movements during tracking, the convergence ability of the objective lens element may be deteriorated.

In the case where the objective lens element is composed of a resin material, the convergence ability may be deteriorated due to changes in the refractive index of the resin material caused by changing temperature. In particular, a recording/reproduction apparatus which is capable of performing recording and reproduction for both the first and second optical disks employs an objective lens element having a high NA (numerical aperture), so that the performance of such an apparatus may substantially deteriorate due to changes in the refractive index.

### SUMMARY

Therefore, an object of the present invention is to solve the above-described problems associated with the conventional techniques by providing: an objective lens element which is only partially provided with diffraction elements to enhance the efficiency of light utility and which has a reduced finite magnification for the second optical disk to improve the off-axis characteristics of the lens; and an optical head device incorporating the objective lens element.

According to the present invention, there is provided an objective lens for recording information on, or reading information from, a first optical medium by utilizing a first light beam which convergences on the first optical medium at a first numerical aperture (hereinafter “NA1”) and for recording information on, or reading information from, a second optical medium by utilizing a second light beam which convergences on the second optical medium at a second numerical aperture (hereinafter “NA2”), wherein NA1 is greater than NA2, having an optical lens for receiving the first light beam and the second light beam having, a peripheral diffraction structure disposed substantially outside an area of incidence of the second light beam for suppressing fluctuation in wavefront aberration of the first light beam; and a phase step structure disposed in a central region relative to the peripheral region for producing a phase difference in the second light beam.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are diagrams showing an optics structure employing an objective lens element for optical disks according to an embodiment of the present invention;

FIG. 2 is a photographic image of an interference fringe, showing wavefront aberration at numerical aperture NA=0.66, in an objective lens element according to an embodiment of the present invention as used in an optical system for converging onto a second optical disk given the wavelength of a second light source;

FIGS. 3A, 3B, and 3C are aberration charts of an objective lens element according to Example 1 of the present invention with respect to a first optical disk;

FIGS. 4A and 4B are aberration charts of an objective lens element according to Example 1 of the present invention with respect to a second optical disk;

FIGS. 5A, 5B, and 5C are aberration charts of an objective lens element according to Example 2 of the present invention with respect to a first optical disk;

FIGS. 6A and 6B are aberration charts of an objective lens element according to Example 2 of the present invention with respect to a second optical disk; and

FIG. 7 is a diagram showing an optics structure of an optical head device according to Example 3 of the present invention.

### DESCRIPTION OF THE PREFERRED EMBODIMENTS

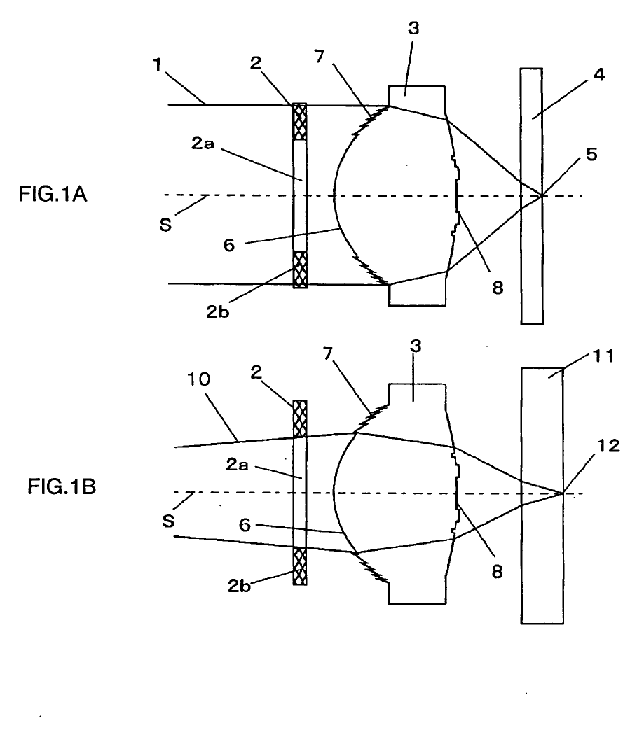

Hereinafter, embodiments of the objective lens element for optical disks according to the present invention will be described with reference to the figures. FIGS. 1A and 1B are diagrams showing an optics structure employing an objective lens element for optical disks according to the present invention. FIG. 1A shows the case where a first optical disk (DVD) is employed. FIG. 1B shows the case where a second optical disk (CD) is employed.

In FIG. 1A, an incident light beam 1 having a first wavelength of 658 nm (λ1) is transmitted through a wavelength filter 2, enters a resin objective lens element 3, and converges on an information recording surface 5 which is on the back face of a first optical disk 4 (having a thickness of 0.6 mm). A central portion 2a of the wavelength filter 2 transmits both the first wavelength λ1 and a second wavelength 780 nm (described later). A peripheral portion 2b of the wavelength filter 2 has characteristics such that only the first wavelength λ1 is transmitted therethrough, while the second wavelength is reflected or absorbed. A face of the objective lens element 3 nearer to a light source (hereinafter referred to as the “first face”) is divided into a central portion 6 and a peripheral portion 7. The central portion 6 has an aspherical surface. The peripheral portion 7 includes saw-tooth-like diffraction elements which are integrally formed on an aspherical surface. A face of the objective lens element 3 nearer to the disk (hereinafter referred to as the “second face”) has phase steps 8 formed thereon.

In FIG. 1A, the incident light beam 1 is parallel light. The objective lens element 3 is designed so as to have a minimum wavefront aberration with respect to parallel light. The phase steps 8, which are formed on an aspherical surface, are designed so as to produce optical path length differences corresponding to integer multiples of the first wavelength λ1. The phase steps 8 having such a structure ensure that the same wavefront aberration as that in the case where the phase steps 8 are not formed at all is obtained with respect to the first wavelength λ1.

The central portion 6 of the first face of the objective lens element 3 is aspherical. Since the objective lens element 3 is composed of resin, changes in the refractive index due to the changing temperature of the resin in the central portion 6, where the diffraction elements are not formed, cause the wavefront aberration to fluctuate. However, the influence of such wavefront aberration fluctuations are substantially negligible because the central portion 6 has an aperture NA of 0.5. However, the entire objective lens element 3, which includes the peripheral portion 7 where diffraction elements are formed, has an NA of 0.65, and therefore would be more susceptible to the influences of temperature changes if the diffraction elements were not provided. The diffraction elements which are formed integrally with the peripheral portion 7 suppress fluctuations in the wavefront aberration by utilizing wavelength fluctuations of the light source which occur concurrently with the temperature changes.

On the other hand, in FIG. 1B, the incident light beam 10 is divergent light. The incident light beam 10, having a second wavelength of 780 nm (λ2), is transmitted through the central portion 2a of the wavelength filter 2, enters the objective lens element 3, and converges on an information recording surface 12 which is on the back face of a second optical disk 11 (having a thickness of 1.2 mm).

The phase steps 8 provided on the second face of the objective lens element 3 produces phase differences with respect to light having the wavelength of λ2. Thus, the phase steps 8 function to reduce a residual spherical aberration which cannot be removed by merely employing divergent light as the incident light beam 10.

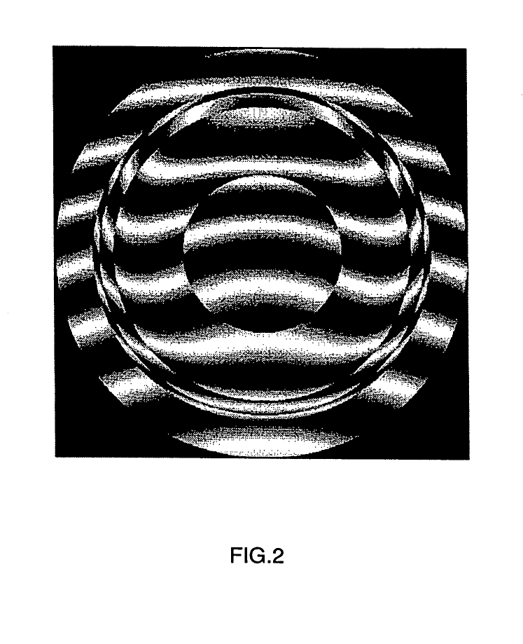

FIG. 2 is a photographic image of an interference fringe, showing a wavefront aberration which occurs when a light beam of the wavelength λ2 converges onto the second optical disk 11 from the objective lens element 3, assuming that the wavelength filter 2 is omitted. Note that a tilt component is introduced to better illustrate the curves of the wavefront. Among the several distinct zones which can be observed in FIG. 2, the outermost zone corresponds to a region which is dedicated only to the first optical disk (i.e., a light component which has been transmitted through the peripheral portion 7 of the objective lens element 3), which would not appear if the wavelength filter were not removed. It will be seen that no outstanding curves are present in the interference fringe. In the absence of the wavelength filter 2, it is considered that an NA which is substantially as large as the first optical disk 4 effectively exists, presumably resulting in an extremely small tilt margin for the second optical disk having a large disk thickness. Moreover, the converged spot diameter is so small that it might affect the recording/reproduction characteristics. Thus, it can be seen that the diffraction elements on the peripheral portion 7 of the objective lens element 3 do not necessarily serve to restrict the aperture when they are designed as means of temperature compensation for a resin lens.

Assuming that the objective lens element 3 has an imaging magnification of m1 at the first wavelength λ1, by ensuring that m1 is substantially zero (i.e., the incident light is parallel light), it becomes possible to prevent performance fluctuations due to a movement of the objective lens element 3 during tracking or the like, with respect to the first optical disk 4 which requires a high NA.

Assuming that the objective lens element 3 has an imaging magnification of m2 for the second optical disk 11, it is desirable that m2 satisfies:
−0.06<m2<−0.03 (1).
If m2 is smaller than the lower limit expressed by equation (1) above, the wavefront aberration for the second optical disk 11 becomes excessive, so that a substantial residual aberration may occur despite the presence of the phase steps, or the phase steps will become too complex and therefore difficult to process. On the other hand, if the magnification m2 is greater than the upper limit expressed by equation (1) above, the wavefront aberration for the second disk 11 might be more reduced, but a wavefront aberration which occurs with a movement of the objective lens element 3 during tracking or the like, i.e., an off-axis wavefront aberration, will become excessive.

Furthermore, it is desirable that the numerical aperture NA1 of the objective lens element 3 with respect to the first optical disk 4 falls within the range of:
0.58<NA1<0.68 (2).
If NA1 is smaller than the lower limit expressed by equation (2) above, the light spot cannot be adequately converged, thus making it difficult to reproduce the high-density first optical disk 4. On the other hand, if NA1 is greater than the upper limit expressed by equation (2) above, a coma aberration occurring when the first optical disk 4 is tilted may become excessive.

Furthermore, it is desirable that the numerical aperture NA2 of the objective lens element 3 with respect to the second optical disk 11 falls within the range of:
0.43<NA2<0.52 (3).
If NA2 is smaller than the lower limit expressed by equation (3) above, the light spot cannot be adequately converged, thus making it difficult to reproduce the second optical disk 11. On the other hand, if NA2 is greater than the upper limit expressed by equation (3) above, a coma aberration occurring when the second optical disk 11 is tilted may become excessive.

The diffraction elements formed on the objective lens element 3 can provide a maximum diffraction efficiency by being blazed so as to maximize the diffraction efficiency with respect to the first wavelength, i.e., 658 nm.

Moreover, the profile of the phase steps 8 can be most lowered by being set to a height for generating a phase difference which is equal to the first wavelength λ1, whereby mold processing and lens fabrication can be facilitated.

In FIGS. 1A and 1B, S represents an optical axis of the objective lens element 3 and the like. As the light beam of the first wavelength λ1 or the second wavelength λ2, a light beam which is emitted from a semiconductor laser (light source) is employed.

Next, exemplary parameters to be used for specific examples (Examples 1 to 3) of the objective lens element for optical disks according to an embodiment of the present invention will be discussed. In each of the Examples, the first face of the objective lens element 3 is the face nearer to the light source, whereas the second face is the face nearer to the disk. It is assumed that the first and second optical disks (a DVD and a CD, respectively) are parallel plates. It is assumed that the first wavelength is 658 nm and that the second wavelength is 780 nm. It is further assumed that the first optical disk has a thickness of 0.6 mm; the second optical disk has a thickness of 1.2 mm; the first optical disk has a refractive index of 1.578206; and the second optical disk has a refractive index of 1.572031.

In the Examples, the following symbols are used in common:
f: a focal length of the objective lens element at the first wavelength;
NA1: a numerical aperture of the objective lens element with respect to the first optical disk;
NA2: a numerical aperture of the objective lens element with respect to the second optical disk;
R1: a radius of curvature of the first face of the objective lens element;
R2: a radius of curvature of the second face of the objective lens element;
d: a thickness of the objective lens element along the optical axis;
n1: a refractive index of the objective lens element with respect to the first wavelength;
n2: a refractive index of the objective lens element with respect to the second wavelength;
fb1: a distance from the second face of the objective lens element to the first optical disk; and
fb2: a distance from the second face of the objective lens element to the second optical disk.

The aspherical surface is expressed by the following equation (AS):

$$X = \frac{{C}_{j} {h}^{2}}{1 + \sqrt{1 - ( 1 + {k}_{i} ) {C}_{j}^{2} {h}^{2}}} + \sum {A}_{j , n} {h}^{n} . \qquad ( AS )$$

In the equation (AS), where the respective symbols have the following meanings:
λ: a distance of a point on an aspherical surface whose height from the optical axis is h, as taken from a tangential plane on an apex of the aspherical surface;
h: a height from the optical axis;
Cⱼ: a curvature at an apex of the aspherical surface on a j^{th} face of the objective lens element (Cj=1/Rj);
kⱼ: a conic constant of the j^{th} face of the objective lens element; and
A_{j,n}: an n^{th}-order aspherical coefficient of the j^{th} face of the objective lens element, where j=1 or 2.

The phase difference which is produced by the diffraction elements added to the aspherical surface is expressed by the following equation (DE):
P=ΣB_{j,m}h^{2m} (DE).

In the equation DE, the respective symbols have the following meanings:
P: a phase difference function;
h: a height from the optical axis; and
Bj,m: a 2m^{th} order phase function coefficient of the j^{th} face of the objective lens element, where j=1 or 2.

### EXAMPLE 1

Exemplary parameters of Example 1 of the objective lens element 3 are given below.
f=2.80
NA1=0.66
NA2=0.50
d=1.75
n1=1.539553
n2=1.535912
fb1=1.4300
fb2=1.1798
m=0.0404
   Inner Portion of the First Face

A height of the boundary between the inner portion and the outer portion from the optical axis: 1.44.
R1=1.7349954
K1=−0.66214051
A1,4=0.0018211551
A1,6=−9.7623013e-5
A1,8=−2.8361915e-5
A1,10=−1.391495e-5
   Outer Portion of the First Face
   An offset of the outer portion, along the optical axis direction, from an intersection between the inner portion and the optical axis: 0.00039887641.
R1=1.711519
K1=−0.6959109
A1,4=0.0019595938
A1,6=−0.00064257738
A1,8=−0.00011655729
A1,10=−1.8406935e-005
B1,2=20.420334
B1,4=−3.2119767
B1,6=−3.1847636
B1,8=−0.18894313
B1,10=−0.0098389883

The second face is divided into five zones.

The first zone has a height of 0 to 0.4654 from the optical axis.

R2=−7.5567993
K2=−27.823207
A2,0=0
A2,4=0.0024668774
A2,6=−0.00063615436
A2,8=0.00010670631
A2,10=−8.2744491e-006
   The second zone has a height of 0.4654 to 0.9569 from the optical axis.
R2=−7.5765327
K2=−27.840444
A2,0=−0.0012189398
A2,4=0.0024638452
A2,6=−0.00063615436
A2,8=0.00010670631
A2,10=−8.2744491e-006
   The third zone has a height of 0.9569 to 1.0794 from the optical axis.
R2=−7.5567993
K2=−27.823207
A2,0=0
A2,4=0.0024668774
A2,6=−0.00063615436
A2,8=0.00010670631
A2,10=−8.2744491e-006
   The fourth zone has a height of 1.0794 to 1.1345 from the optical axis.
R2=−7.5333056
K2=−27.757745
A2,0=0.0012403966
A2,4=0.0024834191
A2,6=−0.00063615436
A2,8=0.00010670631
A2,10=−8.2744491e-6
   The fifth zone has a height of 1.1345 or above from the optical axis.
R2=−7.5567993
K2=−27.823207
A2,0=0.0
A2,4=0.0024668774
A2,6=−0.00063615436
A2,8=0.00010670631
A2,10=−8.2744491e-6

The second face is divided into five zones. The “A2,0” value for each zone represents a dimension of the phase steps along a depth direction. Specifically, on the basis of the first zone, the second zone has an optical path length which is −1 time as much as the wavelength; the third zone has an optical path length which is twice as much as the wavelength; the fourth zone has an optical path length which is equal to the wavelength; and the fifth zone has an optical path length which is 0 times as much as the wavelength. The refractive index of the lens material used for the objective lens element according to the present Example has a temperature dependency of −1×10⁻⁴(/° C). Under these conditions, even if the temperature of the objective lens element 3 changes by ±35° C., the fluctuations of wavefront aberration with respect to the first optical disk are suppressed to only about ±14 mλ, due to the effects provided by the diffraction elements added on the first face. Furthermore, if the wavelength of the semiconductor laser alone changes by ±5 nm, the fluctuations of wavefront aberration are only about ±12 mλ. On the other hand, in the case where no phase steps are formed, the fluctuations of wavefront aberration will increase up to ±20 mλ in the former case and to ±15 mλ in the latter case. Therefore, the phase steps not only alleviate the wavefront aberration with respect to the second optical disk, but also improve the aberration characteristics against wavelength fluctuations and temperature fluctuations with respect to the first optical disk.

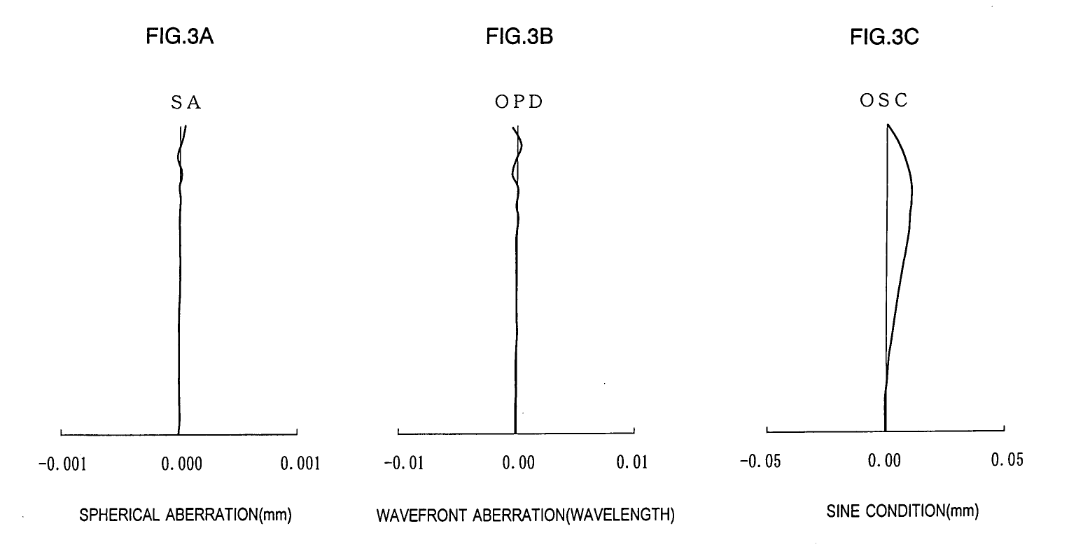

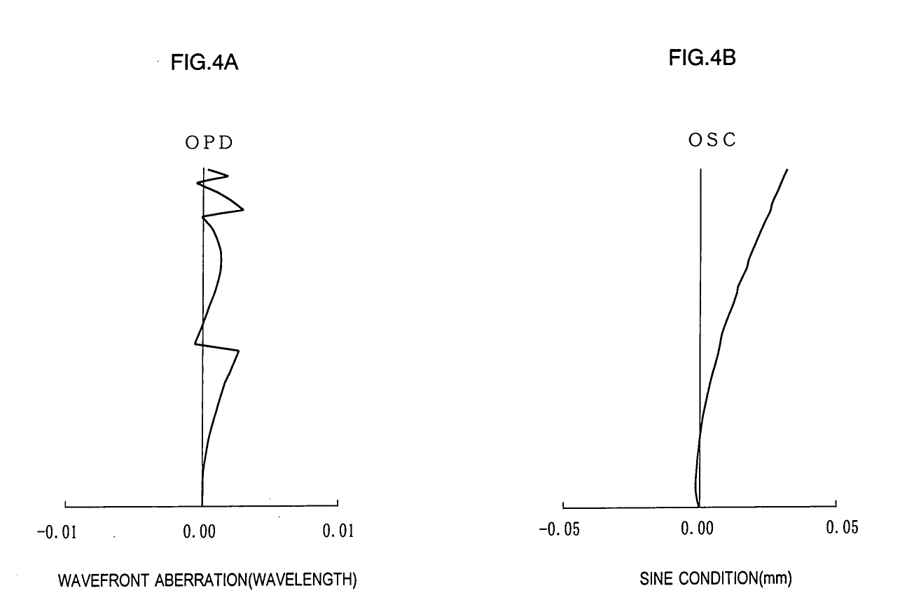

Aberrations (spherical aberration, wavefront aberration, sine condition) for the first optical disk according to Example 1 are shown in FIGS. 3A, 3B, and 3C. As shown in FIGS. 3A to 3C, the aberrations are well corrected for. Aberrations (wavefront aberration, sine condition) for the second disk are shown in FIGS. 4A and 4B, from which it can be seen that the phase steps substantially eliminate the wavefront aberration. The total wavefront aberration is about 40 mλ. Since the sine condition is completely rectified for the first optical disk, a state of over-correction will exist under the optical system conditions for the second optical disk; however, this is will not be a problem in practice.

### EXAMPLE 2

Exemplary parameters of Example 2 of the objective lens element are given below.
f=2.15
NA1=0.66
NA2=0.50
d=1.328
n1=1.539553
n2=1.535912
fb1=1.0279
fb2=0.7702
m=0.0487
   Inner Portion of the First Face
   A height of the boundary between the inner portion and the outer portion from the optical axis: 1.114.
R1=1.3486307
K1=−0.6531717
A1,4=0.0036080467
A1,6=−0.00060680764
A1,8=−0.00018078818
A1,10=−0.00013979424
   Outer Portion of the First Face

An offset of the outer portion, along the optical axis direction, from an intersection between the inner portion and the optical axis: 0.00059277756.
R1=1.2678678
K1=−0.98094668
A1,4=−0.023696397
A1,6=0.035192305
A1,8=−0.013718103
A1,10=0.0015649855
B1,2=121.70209
B1,4=−232.46859
B1,6=183.18992
B1,8=−73.763589
B1,10=9.7400211

The second face is divided into five zones.

The first zone has a height of 0 to 0.3636 from the optical axis.

R2=−5.432731
K2=−33.30397
A2,0=0
A2,4=−0.00017162748
A2,6=0.00098714378
A2,8=−0.00046167794
A2,10=8.0852925e-5
   The second zone has a height of 0.3636 to 0.74294 from the optical axis.
R2=−5.4507848
K2=−33.238065
A2,0=−0.0012201457
A2,4=−0.00012823218
A2,6=0.00098714378
A2,8=−0.00046167794
A2,10=8.0852925e-5
   The third zone has a height of 0.74294 to 0.82575 from the optical axis.
R2=−5.432731
K2=−33.30397
A2,0=−2.6698547e-6
A2,4=−0.00017453173
A2,6=0.00098785239
A2,8=−0.00046167794
A2,10=8.0852925e-005
   The fourth zone has a height of 0.82575 to 0.8894 from the optical axis.
R2=−5.4188015
K2=−33.089852
A2,0=0.0012043741
A2,4=−0.00013866566
A2,6=0.00098714378
A2,8=−0.00046167794
A2,10=8.0852925e-005
   The fifth zone has a height of 0.8894 or above from the optical axis.
R2=−5.432731
K2=−33.30397
A2,0=0.0
A2,4=−0.00017162748
A2,6=0.00098714378
A2,8=−0.00046167794
A2,10=8.0852925e-005

The second face is divided into five zones. The “A2,0” value for each zone represents a dimension of the phase steps along a depth direction. Specifically, on the basis of the first zone, the second zone has an optical path length which is −1 time as much as the wavelength; the third zone has an optical path length which is 0 times as much as the wavelength; the fourth zone has an optical path length which is equal to the wavelength; and the fifth zone has an optical path length which is 0 times as much as the wavelength. The refractive index of the lens material used for the objective lens element according to the present Example has a temperature dependency of −1×10⁻⁴ (/° C.). Under these conditions, even if the temperature of the objective lens element 3 changes by ±35° C., the fluctuations of wavefront aberration with respect to the first optical disk are suppressed to only about ±13 mλ, due to the effects provided by the diffraction elements added on the first face. Furthermore, if the wavelength of the semiconductor laser changes by ±5 nm, the fluctuations of wavefront aberration are only about ±15 mλ. On the other hand, in the case where no phase steps are formed, the fluctuations of wavefront aberration will be ±15 mλ in the former case and ±15 mλ in the latter case. Therefore, in this case, too, the phase steps not only alleviate the wavefront aberration with respect to the second optical disk, but also provide a slight improvement in the aberration characteristics against wavelength fluctuations and temperature fluctuations with respect to the first optical disk.

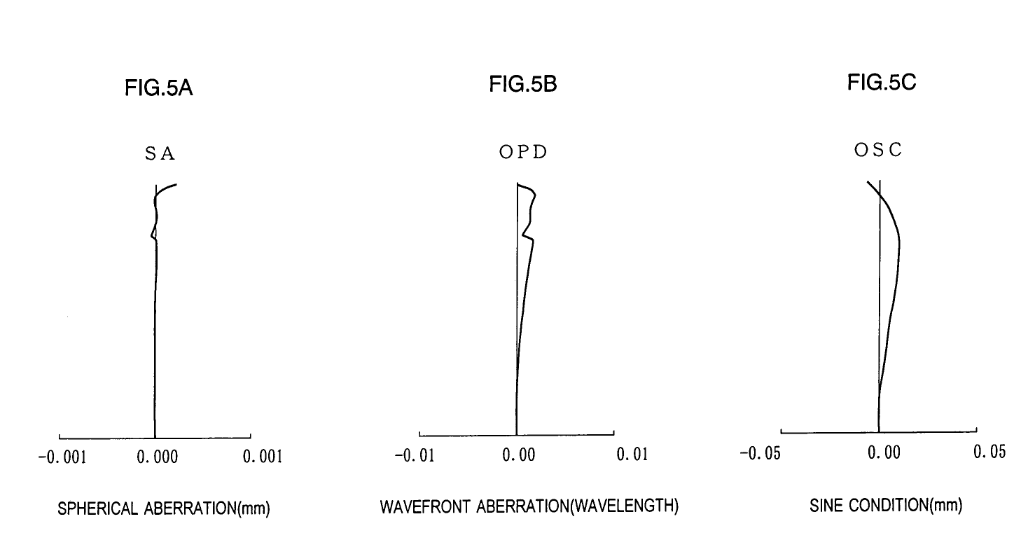

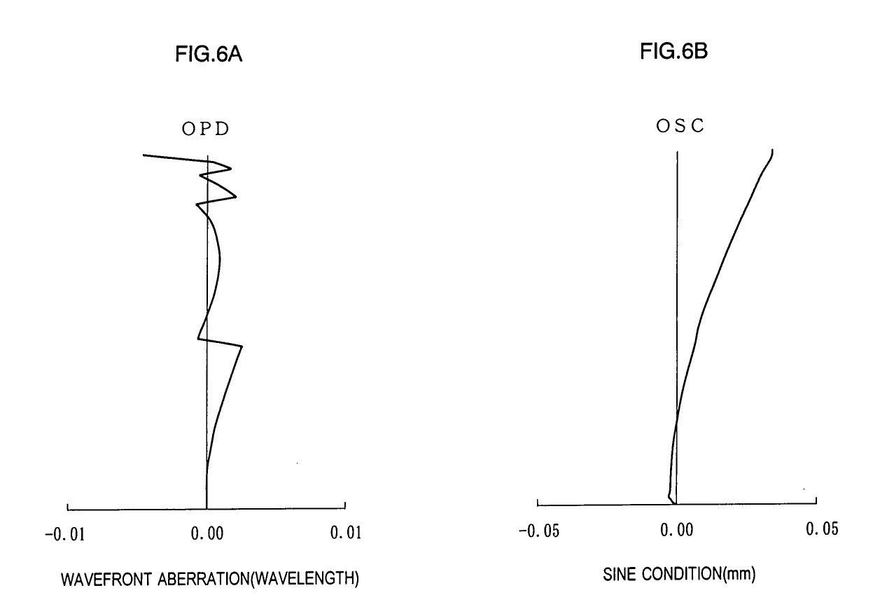

Aberrations (spherical aberration, wavefront aberration, sine condition) for the first optical disk according to Example 2 are shown in FIGS. 5A, 5B, and 5C. As shown in FIGS. 5A to 5C, the aberrations are well corrected for. Aberrations (wavefront aberration, sine condition) for the second disk are shown in FIGS. 6A and 6B, from which it can be seen that the phase steps substantially eliminate the wavefront aberration. The total wavefront aberration is about 40 mλ. Since the sine condition is completely rectified for the first optical disk, a state of over-correction will exist under the optical system conditions for the second optical disk; however, this is will not be a problem in practice.

### EXAMPLE 3

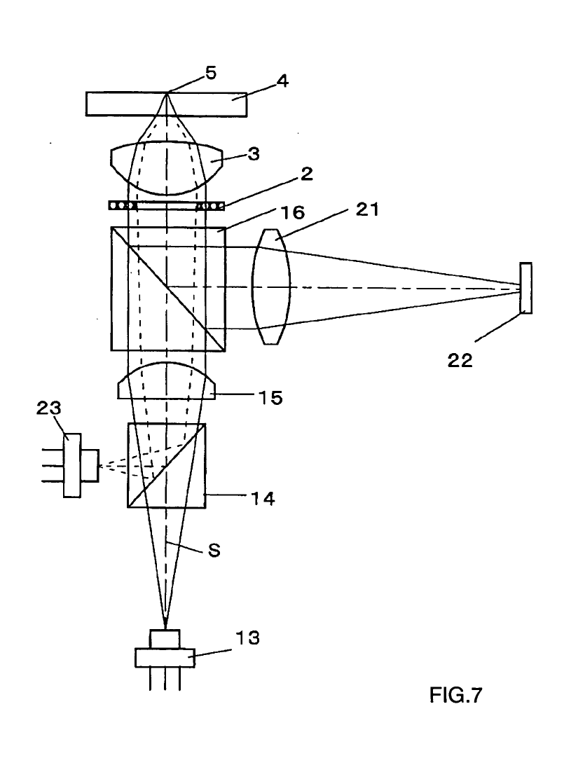

Next, an optical head device incorporating the objective lens element 3 will be described with reference to FIG. 7. FIG. 7 is a diagram showing an optics structure of an optical head device according to Example 3 of the present invention. A light beam which is emitted from a semiconductor laser 13 (first wavelength: 658 nm) is transmitted through a beam splitter 14 which is transmissive to 658 nm, and collimated into parallel light by a collimation lens 15. The parallel light is transmitted through a beam splitter 16, and thereafter is transmitted through a wavelength filter 2 to enter the objective lens element 3. The objective lens element 3 converges a light spot on an information recording surface 5 of a first optical disk 4. The light which has been modulated at the information recording surface 5 returns to the objective lens element 3 so as to be reflected off the beam splitter (light beam separation means) 16, and is directed to a photodetector (light-receiving means) 22 through a detection lens 21. The photodetector 22 reproduces information which is recorded on the information recording surface 5 of the first optical disk 4. At the time of writing (recording), the output power of the semiconductor laser 13 is modulated in order to write information on the information recording surface 5.

As for reproduction from the second optical disk 11 (see FIG. 1B) used instead of the first optical disk 4, a light beam emitted from a semiconductor laser 23 capable of emitting light of a second wavelength (780 nm), instead of the semiconductor laser 13, reflected from the beam splitter 14, and converted to divergent light through the collimation lens 15. After the divergent light is transmitted through the beam splitter 16, the divergent light is transmitted through the wavelength filter 2 so as to enter the objective lens element 3. The objective lens element 3 converges a light spot on an information recording surface of the second optical disk. The light which has been modulated at the information recording surface returns to the objective lens element 3 so as to be reflected off the beam splitter 16, and is directed to the photodetector 22 through the detection lens 21. The photodetector 22 reproduces information which is recorded on the information recording surface of the second optical disk.

It will be appreciated that the face on which to form the phase steps 8 and the face on which to form the diffraction elements 7 may be exchanged. Instead of forming the phase steps 8 and the diffraction elements 7 on different faces of the objective lens element 3, the phase steps 8 and the diffraction elements 7 may be formed on a single face in an integrated manner. Furthermore, the phase steps 8 and/or the diffraction elements 7 may not be integrated with the objective lens element 3, but may instead be provided as separate optical elements.

Furthermore, although the surface configuration of the phase steps 8 is set so as to produce the same phase as the first wavelength, it may alternatively be set so as to produce a phase which is an integer multiple (twice, three times, etc.) of the first wavelength. Depending on the value of the integer selected, it may be possible to further reduce the wavefront aberration for the second optical disk. Similarly, the number of zones into which the phase steps 8 are separated may be increased or decreased within the bounds of the tolerable wavefront aberration for the second optical disk.

The objective lens element for optical disks according to the present invention and an optical head device incorporating the same are most suitable as a lens or an optical head device for performing compatible reproduction/recording for, e.g., a DVD and a CD with a single objective lens element, and may be applicable to an consumer-use optical disk apparatus, an optical memory disk apparatus for a computer, and the like.

While the invention has been described in detail, the foregoing description is in all aspects illustrative and not restrictive. It is understood that numerous other modifications and variations can be devised without departing from the scope of the invention.

1. An objective lens for recording information on, or reading information from, a first optical medium by utilizing a first light beam which convergences on the first optical medium at a first numerical aperture (hereinafter “NA1”) and for recording information on, or reading information from, a second optical medium by utilizing a second light beam which convergences on the second optical medium at a second numerical aperture (hereinafter “NA2”), wherein NA1 is greater than NA2, the objective lens comprising:
an optical lens for receiving the first light beam and the second light beam comprising,
a peripheral diffraction structure disposed substantially outside an area of incidence of the second light beam for suppressing fluctuation in wavefront aberration of the first light beam; and
a phase step structure disposed in a central region relative to the peripheral region for producing a phase difference in the second light beam.

2. The objective lens according to claim 1, wherein the diffraction structure is shaped for reducing a fluctuation in waveform aberration of the objective lens due to a change in temperature of a material composing the objective lens.

3. The objective lens according to claim 1, wherein an imaging magnification m2 of the objective lens at a second wavelength λ2 of the second light beam satisfies the following: −0.06<m2<−0.03.

4. The objective lens according to claim 1, wherein the phase step structure is configured to produce optical path length differences corresponding to integer multiples of a first wavelength λ1 of the first light beam.

5. The objective lens according to claim 1, wherein an imaging magnification m1 of the optical lens with respect to the first light beam is substantially zero.

6. The objective lens according to claim 1, wherein the phase step structure is formed as an integral feature on a face of an aspherical surface.

7. The objective lens according to claim 1, wherein the first optical medium has a thickness of 0.6 mm and the second optical medium has a thickness of 1.2 mm.

8. The objective lens according to claim 1, wherein 0.58<NA1<0.68.

9. The objective lens according to claim 1, wherein 0.43<NA2<0.52.

10. The objective lens according to claim 1, wherein the diffraction structure is blazed for maximizing a diffraction efficiency with respect to the first light beam.

11. The objective lens according to claim 1, wherein the phase step structure has a height for producing a phase difference which is equal to a wavelength λ1 of the first light beam.

12. The objective lens according to claim 1, wherein the peripheral diffraction structure is part of a first aspherical surface and the phase step structure disposed in the central region is part of a second ashperical surface opposing the first aspherical surface.

13. The objective lens according to claim 1, wherein the peripheral diffraction structure and the phase step structure disposed in the central region are part of an ashperical surface of the optical lens.

14. An optical head device for receiving a first light source and a second light source characteristics of which are different from the first light source, comprising:
an objective lens for receiving the first light beam and the second light beam comprising,
a peripheral diffraction structure disposed substantially outside an area of incidence of the second light beam for suppressing fluctuation in wavefront aberration of the first light beam; and
a phase step structure disposed in a central region relative to the peripheral region for producing a phase difference in the second light beam;
a beam splitter for separating a modulated light beam; and
a detector for receiving light from the beam splitter.

15. The optical head device according to claim 14, further comprising a wavelength filter configured to transmit both the first light beam of a wavelength λ1 and the second light beam of a wavelength λ2 and within an aperture ranging between NA2 and NA1, the wavelength filter transmits the first light beam and reflects or absorbs the second light beam.

16. The optical head device according to claim 14, wherein the diffraction structure is shaped for reducing a fluctuation in waveform aberration of the objective lens due to a change in temperature of a material composing the optical lens.

17. The optical head device to claim 14, wherein an imaging magnification m2 of the objective lens at a second wavelength λ2 of the second light beam satisfies the following: −0.06<m2<.−0.03.

18. The optical head device according to claim 14, wherein the phase step structure is configured to produce optical path length differences corresponding to integer multiples of a first wavelength λ1 of the first light beam.

19. The optical head device according to claim 14, wherein an imaging magnification m1 of the objective lens with respect to the first light beam is substantially zero.

20. The optical head device according to claim 14, wherein the phase step structure is formed as an integral feature on an aspherical surface of the optical lens.

21. The optical head device according to claim 14, wherein 0.58<NA1<0.68.

22. The optical head device according to claim 14, wherein 0.43<NA2<0.52.

23. The optical head device according to claim 14, wherein the diffraction structure is blazed for maximizing a diffraction efficiency with respect to the first light beam.

24. The optical head device according to claim 14, wherein the phase step structure has a height for producing a phase difference which is equal to a wavelength λ1 of the first light beam.

25. The optical head device according to claim 14, wherein the peripheral diffraction structure is part of a first aspherical surface and the phase step structure disposed in the central region is part of a second ashperical surface opposing the first aspherical surface.

26. The optical head device according to claim 14, wherein the peripheral diffraction structure and the phase step structure disposed in the central region are part of an ashperical surface of the optical lens.
